(19) United States
(12) Patent Application Publication
(10) Pub. No.: US 2007/0072768 A1
(43) Pub. Date: Mar. 29, 2007

(54) CARBON DIOXIDE ABSORBENT AND METHOD OF MANUFACTURING CARBON DIOXIDE ABSORBENT

(76) Inventors: Kenji Essaki, Kawasaki-shi (JP); Yasuhiro Kato, Yokohama-shi (JP); Masahiro Kato, Naka-gun (JP); Toshihiro Imada, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/534,046

(22) Filed: Sep. 21, 2006

(30) Foreign Application Priority Data
Sep. 28, 2005 (JP) 2005-281652

(51) Int. Cl. B01J 20/00; C04B 33/32

(52) U.S. Cl. 502/400; 502/407; 502/413; 264/628

(57) ABSTRACT

A carbon dioxide absorbent includes a porous body containing a large number of lithium composite oxide particles having an average particle diameter of 2 to 7 μm, the porous body having a porosity of 30 to 80% and also having pores with a diameter of 10 to 25 μm occupying at least 15% by volume of the entire pores.

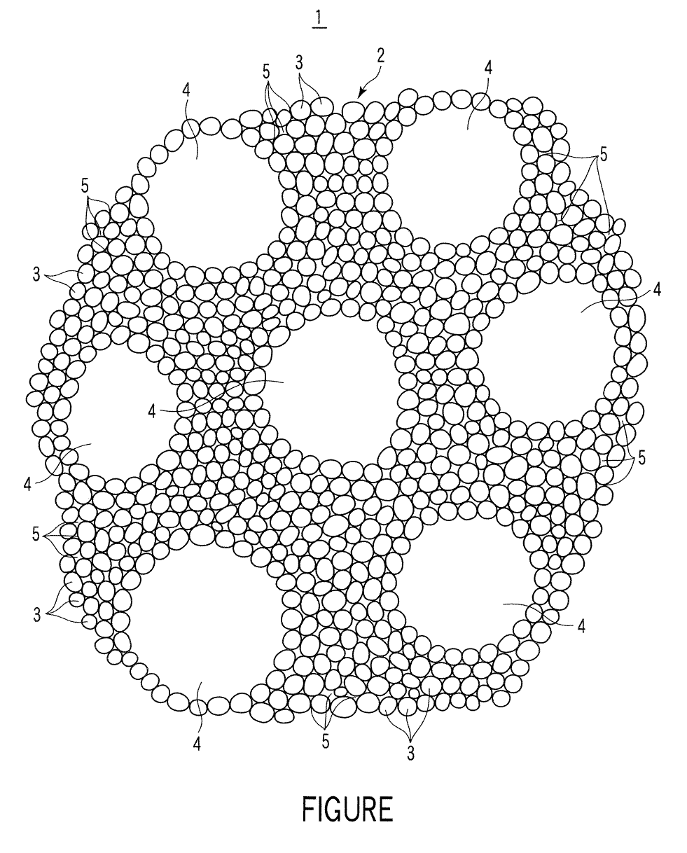

### CROSS-REFERENCE TO RELATED APPLICATIONS

This application is based upon and claims the benefit of priority from prior Japanese Patent Application No. 2005-281652, filed Sep. 28, 2005, the entire contents of which are incorporated herein by reference.

### BACKGROUND OF THE INVENTION

1. Field of the Invention

The present invention relates to a carbon dioxide absorbent and a method of manufacturing the same.

2. Description of the Related Art

As methods of separating carbon dioxide an exhaust gas, a chemical absorption process using an alkanol amine type solvent, a pressure swing method, a low temperature separation method, and a membrane separation method have been known. However, these methods all require the temperature of the gas to be introduced to be around 200° C. or lower because of the limited heat resistance of materials and substances such as membranes and solvents to be employed therefor. Accordingly, even if carbon dioxide separated from a high temperature gas is recycled to a high temperature system, it requires a cooling process by heat exchange or the like and increases the energy to be consumed for the carbon dioxide separation. Accordingly, it inhibits a wide range of its applications.

In such a carbon dioxide separation method, JP-A 9-99214 (KOKAI) discloses a carbon dioxide absorbent containing lithium zirconate. JP-A 2000-262890 (KOKAI) and JP-A 2001-170480 (KOKAI) respectively disclose use of carbon dioxide absorbents containing lithium silicate. These carbon dioxide absorbents containing lithium zirconate and lithium silicate are capable of absorbing carbon dioxide in a temperature range from a room temperature to a temperature exceeding about 500° C. Also, these carbon dioxide absorbents desorb carbon dioxide if they are heated to about 600° C. or higher. Therefore, the above-mentioned carbon dioxide absorbents can perform repeated absorption and desorption. Further, it is described that addition of carbonates of alkali metals selected from lithium, sodium, and potassium to the respective carbon dioxide absorbents promotes the absorption reaction of carbon dioxide.

However, if the carbon dioxide absorption and desorption are carried out repeatedly for the above-mentioned respective carbon dioxide absorbents, grains gradually grow to lessen the pores. As a result, the absorption speed as well as the desorption speed is lowered.

JP-A 2003-326159 (KOKAI) discloses a carbon dioxide absorbent having a carbon dioxide absorption property stable for a long duration by adding at least one compound selected from sodium silicate and potassium silicate to lithium silicate and thereby suppressing grain growth of the lithium silicate.

With respect to a carbon dioxide absorbent having absorbed carbon dioxide, to recover high purity carbon dioxide, carbon dioxide desorption is carried out in high concentration carbon dioxide. However, to desorb carbon dioxide from the above-mentioned carbon dioxide absorbents under such condition, it is necessary to treat the absorbents at a temperature as high as 850° C. Therefore, proceeding of grain growth of the above-mentioned lithium silicate is accelerated. Consequently, even if a component of suppressing grain growth such as sodium silicate is added, grain growth occurs at the time of desorption of carbon dioxide, and thus it becomes difficult to obtain the carbon dioxide desorption property stable for a long duration.

### BRIEF SUMMARY OF THE INVENTION

According to a first aspect of the present invention, there is provided a carbon dioxide absorbent comprising a porous body containing a large number of lithium composite oxide particles having an average particle diameter of 2 to 7 μm, the porous body having a porosity of 30 to 80% and also having pores with a diameter of 10 to 25 μm occupying at least 15% by volume of the entire pores.

According to a second aspect of the present invention, there is provided a method for manufacturing a carbon dioxide absorbent comprising:

preparing a formed body by forming a mixture containing lithium composite oxide particles having a diameter of 2 to 7 μm and graphite powder having a diameter of 10 to 60 μm; and

firing the formed body in atmosphere containing oxygen.

According to a third aspect of the present invention, there is provided a method for manufacturing a carbon dioxide absorbent comprising:

preparing a formed body by forming a powder mixture containing a starting material powder mixture consisting of lithium carbonate powder and metal oxide powder and graphite powder having a diameter of 20 to 80 μm; and

firing the formed body in atmosphere containing oxygen.

According to a fourth aspect of the present invention, there is provided a method for manufacturing a carbon dioxide absorbent comprising:

preparing a formed body by forming a powder mixture containing a starting material powder mixture consisting of lithium carbonate powder and metal oxide powder and graphite powder having a diameter of 10 to 40 μm;

firing the formed body in non-oxidizing atmosphere to form a fired body; and

heating the fired body in atmosphere containing oxygen to burn out the graphite powder in the fired body.

### BRIEF DESCRIPTION OF THE SEVERAL VIEWS OF THE DRAWING

The single FIGURE is a drawing schematically showing the cross-section of a carbon dioxide absorbent of an embodiment.

### DETAILED DESCRIPTION OF THE INVENTION

Hereinafter, a carbon dioxide absorbent and a method of manufacturing the carbon dioxide absorbent according to an embodiment of the present invention will be described in detail.

The carbon dioxide absorbent of an embodiment comprises a porous body containing a large number of lithium composite oxide particles having an average particle diameter of 2 to 7 μm. The porous body has a porosity of 30 to 80%. The porous body also has pores (first pores) with a diameter of 10 to 25 μm and small pores (second pores) with a smaller diameter than that of the first pores dispersed therein. The first pores occupy at least 15% by volume of the entire pores, the total of the first pores and the second pores.

A typical cross-sectional structure of the carbon dioxide absorbent of the embodiment is shown in FIGURE. A carbon dioxide absorbent 1 is a porous body 3 with a porosity of 30 to 80% and containing a large number of lithium composite oxide particles 2 having an average particle diameter of 2 to 7 μm. The porous body 3 has first pores 4 with a diameter of 10 to 25 μm and second pores 5 with a smaller diameter (for example, 7 μm or smaller) than that of the first pores 4 dispersed therein. The first pores 4 occupy at least 15% by volume in the entire pores, that is, all pores of the first pores 4 and the second pores 5 in total.

As the above-mentioned lithium composite oxide, for example, lithium silicate can be used. In the lithium silicate, lithium orthosilicate defined by the chemical formula Li₄SiO₄ is most preferable since it has high carbon dioxide absorption and desorption properties. In this connection, compositions slightly different from the stoichiometric ratio shown in the chemical formula may be included in the lithium silicate. Further, the lithium composite oxide is allowed to include lithium composite oxide particles other than lithium silicate. The lithium composite oxide is preferably lithium titanate, lithium aluminate, and lithium zirconate and particularly desirably lithium titanate. The content of such lithium composite oxide particles other than lithium silicate makes it easy to maintain the morphology of the pores of the porous body in repeated carbon dioxide absorption and desorption.

Since the lithium composite oxide particles in the above-mentioned porous body have an average particle diameter of 2 to 7 μm, a carbon dioxide absorbent having carbon dioxide absorption property and desorption property (particularly the desorption property in ambient conditions of high carbon dioxide concentration and a temperature as high as 850° C.) stable for a long duration can be obtained. If the average particle diameter of the lithium composite oxide particles exceeds 7 μm, the carbon dioxide absorption property and desorption property may possibly be low even from the initial period.

Adjustment of the porosity of the porous body to be 30 to 80% effectively optimizes the packing density of the carbon dioxide absorbent in a reactor and makes the porous body exhibit excellent carbon dioxide adsorption property, and further makes it possible to maintain the strength of the carbon dioxide absorbent. The porosity of the porous body is more preferably 50 to 80%.

The porous body preferably has the first pores with a diameter of 10 to 25 μm and the second pores with a diameter smaller than that of the first pores, for example, 7 μm or smaller. Since the porous body has the first pores with a diameter of 10 to 25 μm therein, the carbon dioxide absorbent having an excellent carbon dioxide absorption property and a carbon dioxide desorption property stable for a long duration can be obtained. Particularly, if the diameter of the first pores is made smaller than 10 μm, during repeated absorption and desorption of carbon dioxide, the pores may be decreased or disappear because of the grain growth of the lithium composite oxide particles. Also, if the maximum diameter of the pores is 25 μm, the porous body can continuously keep proper pores until the carbon dioxide absorption property and desorption property of the lithium composite oxide particles is deteriorated, that is, the particles become coarse.

If the volumetric ratio of the first pores in the porous body is lower than 15% by volume in the entire pores, it becomes difficult to obtain a carbon dioxide absorbent having the carbon dioxide absorption property and desorption property stable for a long duration. The first pores are preferable to occupy 25 to 60% by volume in the entire pores.

The first pores are preferably dispersed evenly in the porous body. For example, the first pores are preferable to be dispersed in a manner that the neighboring first pores are at a distance from one another 0.2 to 2 times as long as that of the pore diameter.

The porous body may have any optional shape, e.g., pellet form, spherical shape and the like.

The average particle diameter of the above-mentioned lithium composite oxide particles and the distance between neighboring first pores can be measured by photographing the cross-sectional views at a plurality of sites of the porous body and carrying out computation from the photographed image. Further, the volume ratio of the first pores to the entire pores can be calculated in accordance with a fine pore distribution measurement method by a mercury intrusion porosimetry.

Next, methods (three manufacturing methods) for manufacturing a carbon dioxide absorbent of the embodiment will be described in detail.

(1) At first, a mixture for forming is produced by mixing lithium composite oxide (for example lithium silicate) particles having an average particle diameter of 2 to 7 μm and a graphite powder having a particle diameter of 10 to 60 μm. Successively, the mixture is formed by granulation or extrusion. The obtained formed body is fired in atmosphere containing oxygen to sinter the lithium silicate particles, and at the same time to burn out the graphite powder to obtain the carbon dioxide absorbent (a porous body) with the above-mentioned structure.

The lithium silicate particles can be obtained by mixing, for example, lithium carbonate powder and silicon dioxide powder as starting materials at Li₂CO₃:SiO₂ molar ratio of 2:1 and causing reaction of the powder mixture at 600 to 1200° C. in an electric furnace.

The graphite powder to be employed may have spherical, bulk type, rectangular parallelepiped, or cubic form. Particularly, the graphite powder is preferable to have a spherical form, a cubic form, and forms almost similar to these forms. Use of the graphite powder with such forms makes it possible to easily control the shapes of the pores having a diameter of 10 to 25 μm and dispersed in the porous body to be spherical or cubic.

Use of the graphite powder with a diameter of 10 to 60 μm makes it easy to control the diameter of the pores in the obtained porous body to be 10 to 25 μm.

The graphite powder is preferable to be added at a ratio of 40 to 400% by weight to the above-mentioned lithium silicate particles.

The firing temperature of the formed body is preferable to be 700 to 850° C. If the firing temperature is lower than 700° C., not only does the graphite powder tend to remain easily but also the strength of the obtained carbon dioxide absorbent (the porous body) may possibly be lowered. On the other hand, if the firing temperature exceeds 850° C., the obtained carbon dioxide absorbent (the porous body) shrinks to make it difficult to control the pore diameter and the porosity.

The firing is preferable to be carried out in an atmosphere containing oxygen, particularly in atmospheric air. If firing is carried out in atmosphere containing no oxygen, it becomes difficult to burn out the graphite powder dispersed in the formed body and to obtain an aimed porous body (a carbon dioxide absorbent) having the prescribed pores. Also, if firing is carried out in oxygen-containing gas atmosphere with an oxygen concentration higher than that of air, oxidation and burning of the graphite powder dispersed in the formed body quickly proceeds to form locally high temperature parts. Formation of such locally high temperature parts locally promotes grain growth of lithium silicate particles and it may possibly result in deterioration of the carbon dioxide absorption property and desorption property of the obtained carbon dioxide absorbent.

(2) At first, lithium carbonate powder and metal oxide powder (for example, silicon dioxide) as starting materials are mixed at a ratio as Li₂CO₃:SiO₂=2:1. Then, this starting material mixed powder and graphite powder having a diameter of 20 to 80 μm are mixed to obtain a mixture for forming. Successively, the mixture is formed by granulation or extrusion. The obtained formed body is fired in atmosphere containing oxygen to obtain the carbon dioxide absorbent (a porous body) with the above-mentioned structure.

As described in the method (1), the graphite powder to be employed may have spherical, bulk type, rectangular parallelepiped, or cubic form. Particularly, the graphite powder is preferably has a spherical form, a cubic form, and forms almost similar to these forms.

Use of the graphite powder with a diameter of 20 to 80 μm makes it easy to control the diameter of the pores of the obtained porous body to be 10 to 25 μm. The diameter of the graphite powder is more preferably 30 to 60 μm.

The graphite powder is preferably added at a ratio of 20 to 200% by weight to the above-mentioned starting material mixed powder.

As described in the method (1), the firing temperature of the formed body is preferably 700 to 850° C.

(3) At first, lithium carbonate powder and metal oxide powder (for example, silicon dioxide) as starting materials are mixed at Li₂CO₃:SiO₂ molar ratio of 2:1. The starting material mixed powder and graphite powder having a diameter of 10 to 40 μm are mixed to obtain a mixture for forming. Successively the mixture is formed by granulation or extrusion. The obtained formed body is fired in non-oxidative atmosphere and successively the resulting fired body is heated in atmosphere containing oxygen to burn out the graphite powder in the fired body, thereby manufacturing the carbon dioxide absorbent (a porous body) with the above-mentioned structure.

As described in the method (1), the graphite powder to be employed may have spherical, bulk type, rectangular parallelepiped, or cubic form. Particularly, the graphite powder is preferably has a spherical form, a cubic form, and forms almost similar to these forms.

Use of the graphite powder with a diameter of 10 to 40 μm makes it easy to control the diameter of the pores in the obtained porous body to be 10 to 25 μm.

The graphite powder is preferably added at a ratio of 50 to 150% by weight to the above-mentioned starting material mixed powder.

The firing (the first step heating treatment) of the formed body is preferable to be carried out at 600 to 850° C. in non-oxidative atmosphere such as argon or helium. A fired body containing primary particles of lithium silicate and graphite powder is obtained by the first step heating treatment in such a manner.

The above-mentioned heating treatment (the second step heating treatment) of the obtained fired body is preferably carried out at 700 to 850° C. in oxygen-containing atmosphere just like air. A carbon dioxide absorbent (a porous body) with the structure described above is manufactured by burning out the graphite powder dispersed in the fired body in the second step heating treatment.

In the case where a porous body having pores with a diameter of 10 to 25 μm is formed by burning out the graphite powder in such two-step heating, since heating treatment is scarcely accompanied with shrinkage, the pore diameter of the final pores is made to be almost the same as the diameter of the graphite powder. As a result, since the above-mentioned graphite powder having a diameter of 10 to 40 μm approximately the same as the diameter of the pores of the porous body can be used, the pore diameter of the porous body is made easily controllable.

As described, according to the embodiment, there can be obtained carbon dioxide absorbents having excellent carbon dioxide absorption property and carbon dioxide desorption property stable for a long duration in high carbon dioxide concentration and high temperature conditions and capable of stably recovering carbon dioxide discharged from a combustion apparatus as high purity carbon dioxide for a long duration.

That is, the inventors of the invention have made investigations on cause of the deterioration of the carbon dioxide desorption property owing to repeated use, with respect to a carbon dioxide absorbent comprising a porous body containing a large number of lithium composite oxide particles. As a result, the cause is attributed to the decrease of the pores due to the grain growth (grain growth of lithium composite oxide particles) of the carbon dioxide absorbent at the time of absorption and desorption of carbon dioxide at a high temperature. Particularly, in the case where heating is required at a temperature as high as 850° C. for desorbing carbon dioxide from the carbon dioxide absorbent in a high concentration of carbon dioxide in order to recover high purity carbon dioxide, grain growth of the above-mentioned lithium composite oxide particles is promoted.

When the pores of the porous body composing the carbon dioxide absorbent are decreased, the remaining pores are clogged with carbonates formed by the absorption reaction of carbon dioxide. The carbon dioxide absorbent the pores of which are clogged cannot desorb carbon dioxide from the inside and clogging gradually proceeds from the surface to the inside. Accordingly, the carbon dioxide desorption property is considerably deteriorated because of the repeated use.

Therefore, since the carbon dioxide absorbent of the embodiment comprises a porous body containing a large number of lithium composite oxide particles with an average particle diameter of 2 to 7 μm and having a porosity of 30 to 80% and the pores having a diameter of 10 to 25 μm occupy at least 15% by volume in the entire pores, the carbon dioxide absorbent has excellent carbon dioxide absorption property. Also, even if the grain growth of the lithium composite oxide particles occurs at the time of carbon dioxide absorption and desorption at a high temperature, since pores with a diameter of 10 to 25 μm exist in the carbon dioxide absorbent, clogging of the pores with carbonates produced by the absorption reaction of the carbon dioxide in the initial stage can be prevented. As a result, carbon dioxide can be desorbed not only from the surface but also from the inside of the carbon dioxide absorbent having absorbed carbon dioxide by defining the pore diameter of the pores, the occupation ratio of the pores, and the porosity to be specified values. Consequently, the carbon dioxide absorbent having stable carbon dioxide desorption property for a long duration in conditions of high carbon dioxide concentration and high temperature and capable of stably recovering high purity carbon dioxide for a long duration from carbon dioxide discharged out of a combustion apparatus.

According to the methods (1) to (3) of the embodiment, a carbon dioxide absorbent having stable carbon dioxide desorption property for a long duration in conditions of high carbon dioxide concentration and high temperature and capable of stably recovering high purity carbon dioxide for a long duration from carbon dioxide discharged out of a combustion apparatus can be produced.

Particularly, according to the method (3), since shrinkage is scarcely caused at the time of burning out the graphite powder for forming pores by carrying out two-step heating, that is, firing in non-oxidizing atmosphere and heating in oxygen-containing atmosphere, it is made possible to approximate the pore diameter (10 to 40 μm) of the porous body to the diameter of the graphite powder. Therefore, since the above-mentioned graphite powder having a diameter of 10 to 40 μm approximately the same as the pore diameter of the pores can be used, the pore diameter of the porous body is made easily controllable. As a result, the carbon dioxide absorbent having the above-mentioned structure, particularly the pore diameter, can be produced at a high reproducibility.

Hereinafter, the invention will be described more in detail along with Examples.

### EXAMPLE 1

Silicon dioxide powder with an average particle diameter of 10 μm, lithium carbonate powder with an average particle diameter of 1 μm, and potassium carbonate powder with an average particle diameter of 1 μm were weighed to adjust their molar ratio at Li₂CO₃:SiO₂:K₂CO₃=2:1:0.1. Fibrous lithium titanate powder with an average particle diameter of 0.5 μm and an average length of 15 μm in an amount of 10% by weight in the entire powder was added to the obtained powder mixture and the powder mixture was mixed while being milled by a ball mill to obtain a starting material powder mixture. Successively, the starting material powder mixture was heated at 900° C. for 8 hours in air atmosphere in a box type electric furnace, cooled, taken out of the furnace, crushed, and sieved to synthesize a lithium silicate powder with an average primary particle diameter of 3 μm and containing lithium titanate.

Next, the lithium silicate powder and spherical graphite powder with a diameter of 20 μm were mixed at a ratio of 100% by weight of the graphite powder to the lithium silicate to obtain a mixture for forming. The mixture was packed in a die with an inner diameter of 5 mm and pressure-molded to obtain a formed body with a diameter of 5 mm and a length of 5 mm. Successively, the molded body was fired at 750° C. for 8 hours in air atmosphere to manufacture a carbon dioxide absorbent.

The obtained carbon dioxide absorbent was a porous body containing a large number of lithium silicate particles with an average particle diameter of 3 μm and having a porosity of 74%. In the porous body, first pores having an average diameter of 12 μm and second pores having an average diameter of 3 μm or less, smaller than that of the first pores were dispersed. The porous body had a structure in which the first pores occupied 30% by volume in the total volume of the first pores and the second pores in the porous body and the distance of the neighboring first pores was 0.5 to 1.2 times as large as the diameter of the first pores. The porosity was measured by mercury intrusion porosimetry using trade name: Autopore 9520, manufactured by Shimadzu Corp. The lithium silicate particle diameter, the average particle diameters of the first and the second pores, and the distance between the neighboring first pores of the porous body were calculated by observing 10 points in the cross-section with a microscope.

### EXAMPLE 2

Silicon dioxide powder with an average particle diameter of 10 μm, lithium carbonate powder with an average particle diameter of 1 μm, and potassium carbonate powder with an average particle diameter of 1 μm were weighed to adjust their molar ratio at Li₂CO₃:SiO₂:K₂CO₃=2:1:0.1. Fibrous lithium titanate powder with an average particle diameter of 0.5 μm and an average length of 15 μm in an amount of 10% by weight in the entire powder was added to the obtained powder mixture and the powder mixture was mixed while being milled by a ball mill to obtain a starting material powder mixture. Successively, the starting material powder mixture was heated at 900° C. for 8 hours in air atmosphere in a box type electric furnace, cooled, taken out of the furnace, crushed, and sieved to synthesize a lithium silicate powder with an average primary particle diameter of 4 μm and containing lithium titanate.

Next, the lithium silicate powder and spherical graphite powder with a diameter of 40 μm were mixed at a ratio of 100% by weight of the graphite powder to the lithium silicate to obtain a mixture for forming. The mixture was packed in a die with an inner diameter of 5 mm and pressure-molded to obtain a formed body with a diameter of 5 mm and a length of 5 mm. Successively, the molded body was heated at 750° C. for 8 hours in air atmosphere to manufacture a carbon dioxide absorbent.

The obtained carbon dioxide absorbent was a porous body containing a large number of lithium silicate particles with an average particle diameter of 4 μm and having a porosity of 67%. In the porous body, first pores having an average diameter of 23 μm and second pores having an average diameter of 4 μm or less, smaller than that of the first pores were dispersed. The porous body had a structure in which the first pores occupied 28% by volume in the total volume of the first pores and the second pores in the porous body and the distance of the neighboring first pores was 0.4 to 1 times as large as the diameter of the first pores. The porosity, the lithium silicate particle diameter, the average particle diameters of the first and the second pores, and the distance between the neighboring first pores of the porous body were calculated by the same methods as in Example 1.

### Comparative Example 1

Silicon dioxide powder with an average particle diameter of 10 μm, lithium carbonate powder with an average particle diameter of 1 μm, and potassium carbonate powder with an average particle diameter of 1 μm were weighed to adjust their molar ratio at Li₂CO₃:SiO₂:K₂CO₃=2:1:0.1. Fibrous lithium titanate powder with an average particle diameter of 0.5 μm and an average length of 15 μm in an amount of 10% by weight in the entire starting material powder was added to the obtained powder mixture and the powder mixture was mixed while being milled by a ball mill to obtain a starting material powder mixture. Successively, the starting material powder mixture was heated at 750° C. for 8 hours in air atmosphere in a box type electric furnace, cooled, taken out of the furnace, crushed, and sieved to synthesize a lithium silicate powder with 3 μm size and containing lithium titanate.

Next, the lithium silicate powder was packed in a die with an inner diameter of 5 mm and pressure-molded to obtain a formed body with a diameter of 5 mm and a length of 5 mm. Successively, the molded body was fired at 750° C. for 8 hours in air atmosphere to manufacture a carbon dioxide absorbent.

The obtained carbon dioxide absorbent was a porous body containing a large number of lithium silicate particles with an average particle diameter of 3 μm and having a porosity of 68%. The porous body had a structure in which pores having an average diameter of 3 μm existed in the grain boundaries of the lithium silicate particles and pores having an average diameter of 4 μm occupied 90% by volume in the total volume of the pores. The porosity, the lithium silicate particle diameter, and the average particle diameters of the pores were calculated by the same methods as in Example 1.

### Comparative Example 2

Silicon dioxide powder with an average particle diameter of 10 μm, lithium carbonate powder with an average particle diameter of 1 μm, and potassium carbonate powder with an average particle diameter of 1 μm were weighed to adjust their molar ratio at Li₂CO₃:SiO₂:K₂CO₃=2:1:0.1. Fibrous lithium titanate powder with an average particle diameter of 0.5 μm and an average length of 15 μm in an amount of 10% by weight in the entire starting material powder was added to the obtained powder mixture and the powder mixture was mixed while being milled by a ball mill to obtain a starting material powder mixture. Successively, the starting material powder mixture was heated at 900° C. for 8 hours in air atmosphere in a box type electric furnace, cooled, taken out of the furnace, crushed, and sieved to synthesize a lithium silicate powder with an average primary particle diameter of 4 μm and containing lithium titanate.

Next, the lithium silicate powder and spherical graphite powder with a diameter of 80 μm were mixed at a ratio of 300% by weight of the graphite powder to the lithium silicate to obtain a mixture for forming. The mixture was packed in a die with an inner diameter of 5 mm and pressure-molded to obtain a formed body with a diameter of 5 mm and a length of 5 mm. Successively, the molded body was heated at 750° C. for 8 hours in air atmosphere to manufacture a carbon dioxide absorbent.

The obtained carbon dioxide absorbent was a porous body containing a large number of lithium silicate particles with an average particle diameter of 4 μm and having a porosity of 55%. In the porous body, pores having an average diameter of 50 μm existed, pores with 30 μm or larger occupied 70% by volume in the entire pores, and pores having a diameter of 10 to 25 μm occupied 10% by volume in the entire pores. The porous body had a structure in which the distance of the neighboring pores with 30 μm or larger was 0.4 to 1 times as large as the pore diameter. The porosity, the lithium silicate particle diameter, the average particle diameters of the pores, and the distance between the neighboring pores of the porous body were calculated by the same methods as in Example 1.

The carbon dioxide absorbents of Examples 1 and 2 and Comparative Examples 1 and 2 were set in a tubular electric furnace and while a gas mixture containing 10% by volume of carbon dioxide and 90% by volume of nitrogen gas was circulated in the electric furnace, the carbon dioxide absorbents were kept at 600° C. for 1 hour to absorb carbon dioxide. After that, the ambient gas in the tubular electric furnace was changed to 100% by volume of carbon dioxide and it was heated to 850° C. and kept at the same temperature for 1 hour to desorb carbon dioxide. This absorption and desorption was defined as one cycle and on completion of the desorption, a gas mixture containing 10% by volume of carbon dioxide and 90% by volume of nitrogen gas was again circulated in the electric furnace and it was cooled to 600° C. and then the next cycle was repeated.

The respective carbon dioxide absorbents repeatedly subjected to 49 cycles of the absorption and desorption of carbon dioxide were taken out of the tubular electric furnace and subjected to a 50th cycle of the absorption and desorption of carbon dioxide by trade name: TG-DTA 2500 manufactured by MAC Science. That is, while a gas mixture containing 10% by volume of carbon dioxide and 90% by volume of nitrogen gas was circulated in the electric furnace, the carbon dioxide absorbents were kept at 600° C. for 1 hour to absorb carbon dioxide and thereafter, the gas mixture was changed to 100% by volume of carbon dioxide and it was heated to 850° C. and kept at 850° C. for 1 hour to release carbon dioxide from the carbon dioxide absorbents. In this case, the heating speed to 850° C. was controlled to be 5° C./min and the time from starting desorption to the time of completion of desorption was measured. The inverse number of the measured value×100/min was defined as the repeating desorption capability for evaluation. The results are shown in the following Table 1. The desorption capability at the first time was also shown in Table 1.

TABLE 1

| | Desorption | Desorption |
|---|---|---|
| | capability at | capability at |
| | the first time | the fiftieth time |
| Example 1 | 3.9-4.2 | 3.9 |
| Example 2 | | 3.7 |
| Comparative | | 2.0 |
| Example 1 | | |
| Comparative | | 2.4 |
| Example 2 | | |

As is made clear from Table 1, as compared with Comparative Examples 1 and 2, the carbon dioxide absorbents of Examples 1 and 2 were found to keep the desorption capability close to that at the first time after repeating 50 cycles of carbon dioxide absorption and desorption and thus having high carbon dioxide desorption capability.

### EXAMPLE 3

Silicon dioxide powder with an average particle diameter of 10 μm, lithium carbonate powder with an average particle diameter of 1 μm, and potassium carbonate powder with an average particle diameter of 1 μm were weighed to adjust their molar ratio at Li₂CO₃:SiO₂:K₂CO₃=2:1:0.1. Fibrous lithium titanate powder with an average particle diameter of 0.5 μm and an average length of 15 μm in an amount of 10% by weight in the entire powder mixture was added to the obtained powder mixture and the powder mixture was mixed while being milled by a ball mill to obtain a starting material powder mixture. Successively, the starting material powder mixture was heated at 900° C. for 8 hours in air atmosphere in a box type electric furnace, cooled, taken out of the furnace, crushed, and sieved to synthesize a lithium silicate powder with an average primary particle diameter of 3 μm and containing lithium titanate.

Next, the lithium silicate powder and spherical graphite powder with a diameter of 25 μm were mixed at a ratio of 100% by weight of the graphite powder to the lithium silicate to obtain a powder for forming. The powder for forming was packed in a die with an inner diameter of 5 mm and pressure-molded to obtain a formed body with a diameter of 5 mm and a length of 5 mm. Successively, the molded body was heated at 750° C. for 8 hours in argon atmosphere and further heated at 750° C. for 8 hours in air atmosphere to produce a carbon dioxide absorbent.

The obtained carbon dioxide absorbent was a porous body containing a large number of lithium silicate particles with an average particle diameter of 3 μm and having a porosity of 69%. In the porous body, first pores having an average diameter of 20 μm and second pores having an average diameter of 3 μm, smaller than that of the first pores were dispersed. The porous body had a structure in which the first pores occupied 40% by volume in the total volume of the first pores and the second pores in the porous body and the distance of the neighboring first pores was 0.7 to 1.2 times as large as the diameter of the first pores. The porosity, the diameter of primary particles of lithium silicate, the average particle diameters of the first and the second pores, and the distance between the neighboring first pores of the porous body were calculated by the same methods as in Example 1.

The carbon dioxide absorbent of Example 3 was subjected repeatedly to carbon dioxide absorption and desorption by the same method as that in Example 1 and the desorption capability at the first time and the desorption capability at the fiftieth time were evaluated.

Consequently, the desorption capability at the first time and at the fiftieth time was 4.1 and 4.0, respectively, to find that the desorption capability was still high even after repeating 50 cycles of carbon dioxide absorption and desorption.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A carbon dioxide absorbent comprising a porous body containing a large number of lithium composite oxide particles having an average particle diameter of 2 to 7 μm, the porous body having a porosity of 30 to 80% and also having pores with a diameter of 10 to 25 μm occupying at least 15% by volume of the entire pores.

2. The absorbent according to claim 1, wherein the lithium composite oxide particles contain lithium silicate.

3. The absorbent according to claim 1, wherein the porous body has a porosity of 50 to 80%.

4. The absorbent according to claim 1, wherein the porous body has pores with a diameter of 10 to 25 μm and small pores with a smaller diameter than that of the former pores, and the former pores occupy at least 15% by volume of the entire pores of the former pores and the latter pores in total.

5. The absorbent according to claim 4, wherein the smaller pores have a diameter of 7 μm or smaller.

6. The absorbent according to claim 1, wherein the pores occupy 25 to 60% by volume of the entire pores.

7. A method for manufacturing a carbon dioxide absorbent comprising:
preparing a formed body by forming a mixture containing lithium composite oxide particles having a diameter of 2 to 7 μm and graphite powder having a diameter of 10 to 60 μm; and
firing the formed body in atmosphere containing oxygen.

8. The method according to claim 7, wherein the lithium composite oxide is lithium silicate.

9. The method according to claim 7, wherein the graphite powder is added at a ratio of 40 to 400% by weight to the lithium composite oxide particles.

10. The method according to claim 7, wherein the firing temperature is 700 to 850° C.

11. A method for manufacturing a carbon dioxide absorbent comprising:
preparing a formed body by forming a powder mixture containing a starting material powder mixture consisting of lithium carbonate powder and metal oxide powder and graphite powder having a diameter of 20 to 80 μm; and
firing the formed body in atmosphere containing oxygen.

12. The method according to claim 11, wherein the metal oxide is silicon dioxide.

13. The method according to claim 11, wherein the graphite powder has a diameter of 30 to 60 μm.

14. The method according to claim 11, wherein the graphite powder is added at a ratio of 20 to 200% by weight to the starting material powder mixture.

15. The method according to claim 11, wherein the firing temperature is 700 to 850° C.

16. A method for manufacturing a carbon dioxide absorbent comprising:
preparing a formed body by forming a powder mixture containing a starting material powder mixture consisting of lithium carbonate powder and metal oxide powder and graphite powder having a diameter of 10 to 40 μm;
firing the formed body in non-oxidizing atmosphere to form a fired body; and
heating the fired body in atmosphere containing oxygen to burn out the graphite powder in the fired body.

17. The method according to claim 16, wherein the metal oxide is silicon dioxide.

18. The method according to claim 16, wherein the graphite powder is added at a ratio of 50 to 150% by weight to the starting material powder mixture.

19. The method according to claim 16, wherein the firing temperature is 600 to 850° C.

20. The method according to claim 16, wherein the heating temperature is 700 to 850° C.
